(19) United States
(12) Patent Application Publication
(10) Pub. No.: US 2022/0307526 A1
(43) Pub. Date: Sep. 29, 2022

(54) HYBRID VEHICLE CONTROL METHOD

(71) Applicants: Hyundai Motor Company, Seoul (KR); Kia Corporation, Seoul (KR)

(72) Inventors: Bong Uk Bae, Daegu (KR); Seong Min Son, Pohang (KR); Se Hwan Jo, Bucheon (KR); Kyung Moo Lee, Yongin (KR)

(21) Appl. No.: 17/524,147

(22) Filed: Nov. 11, 2021

(30) Foreign Application Priority Data
Mar. 24, 2021 (KR) 10-2021-0038204

(51) Int. Cl. F15B 15/20

(52) U.S. Cl. CPC F15B 15/204; B60K 6/22

(57) ABSTRACT

A hybrid vehicle control method includes: monitoring an electric oil pump (EOP) driving current in which an EOP is being driven at a predetermined target RPM, and determining whether the EOP driving current is in a predetermined reference range in which it possible to estimate a situation in which the EOP suctions air; determining whether a measured hydraulic pressure at a place receiving oil supplied by the EOP is less than reference hydraulic pressure when the EOP driving current is in the predetermined reference range; and temporarily decreasing line pressure and increasing an RPM of the EOP.

### CROSS REFERENCE TO RELATED APPLICATION

The present application claims under 35 U.S.C. § 119(a) the benefit of Korean Patent Application No. 10-2021-0038204, filed Mar. 24, 2021, the entire contents of which are incorporated by reference herein.

### BACKGROUND

### (a) Technical Field

The present disclosure relates to a method of controlling a transmission of a hybrid vehicle in which an electric oil pump (EOP) is provided for supplying necessary hydraulic pressure to the transmission.

### (b) Description of the Related Art

A hybrid vehicle operates using an engine and a motor as power sources, and the hybrid vehicle and some conventional vehicles include an idle stop function. In addition, most hybrid vehicles are equipped with an EOP generating oil pressure for operating, lubricating, and cooling the transmission independently from driving of the engine. Recently, most hybrid vehicles are equipped with only an EOP without a mechanical oil pump, and the present disclosure relates to a vehicle equipped with only an EOP.

The hydraulic pressure supplied from the EOP is used not only for lubricating and cooling a transmission, but as control-hydraulic pressure for shifting and control-hydraulic pressure of an engine clutch that connects/disconnects an engine and a transmission.

When an EOP is driven, the EOP may suction air due to lack of oil amount to be suctioned by the EOP.

That is, the oil amount to be suctioned by an EOP is insufficient due to lack of flow rate returning to an oil pan, etc. when a vehicle is turned, driven an uphill or a downhill, or driven at an extremely low temperature, so the EOP may suction air.

In this case, even though the EOP is driven at a desired RPM, the flow rate actually discharged from the EOP is insufficient, so the operability of a transmission, a clutch, etc. and lubricating and cooling functions may be remarkably reduced.

The description provided above as a related art of the present disclosure is just for helping understanding the background of the present disclosure and should not be construed as being included in the related art known by those skilled in the art.

### SUMMARY

An objective of the present disclosure is to provide a hybrid vehicle control method that can secure operability of a transmission, a clutch, etc. and stability of lubricating and cooling functions by sensing a situation in which an EOP suctions air and by appropriately coping with the situation so that the discharge flow rate of the EOP can be quickly recovered to the normal level.

In order to achieve the objectives of the present disclosure, a hybrid vehicle control method includes: monitoring an electric oil pump (EOP) driving current in which an EOP is being driven at a predetermined target RPM, and determining whether the EOP driving current is in a predetermined reference range corresponding to a situation in which the EOP suctions air; determining whether a measured hydraulic pressure at a place receiving oil supplied by the EOP is less than a reference hydraulic pressure when the EOP driving current is in the predetermined reference range; and temporarily decreasing line pressure and increasing an RPM of the EOP.

When the EOP driving current is less than a predetermined first reference value, the EOP driving current may be determined as being in the predetermined reference range; and when the EOP driving current is less than or equal to a predetermined second reference value that is smaller than the first reference value and when the measured hydraulic pressure is less than the reference hydraulic pressure, the line pressure may be decreased and the RPM of the EOP may be increased in a method discriminated from a case in which the EOP driving current exceeds the second reference value.

When the EOP driving current is less than the first reference value and exceeds the second reference value and the measured hydraulic pressure is less than the reference hydraulic pressure, the line pressure may be decreased by resetting the target line pressure by multiplying the current line pressure by a predetermined first reference ratio for a predetermined first setting time and the RPM of the EOP may be increased by resetting the target RPM by adding a predetermined first increment to the current target RPM of the EOP.

When the EOP driving current is less than or equal to the second reference value and the measured hydraulic pressure is less than the reference hydraulic pressure, the line pressure may be decreased for a predetermined second setting time; and when a predetermined delay time elapses after the line pressure start to be decreased, the target RPM of the EOP may be increased for a predetermined third setting time.

When the second line pressure is decreased for the second setting time, the target line pressure is reset by multiplying current target line pressure by a predetermined second reference ratio that is smaller than the first reference ratio, whereby the line pressure may be decreased; and when the RPM of the EOP is increased for the third setting time, the target RPM is reset by adding a predetermined second increment to a current target RPM of the EOP, whereby the RPM of the EOP may be increased.

The EOP driving current that is monitored may be a q-axial current of a motor driving the EOP.

The place receiving the oil supplied from the EOP may be an engine clutch connecting an engine and a transmission to each other; and the measured hydraulic pressure may be measured by a hydraulic sensor installed on the engine clutch.

According to the present disclosure, it is possible to secure operability of a transmission, a clutch, etc. and stability of lubricating and cooling functions by sensing a situation in which an EOP suctions air and by appropriately coping with the situation so that the discharge flow rate of the EOP can be quickly recovered to the normal level.

### BRIEF DESCRIPTION OF THE DRAWINGS

The above and other objectives, features and other advantages of the present disclosure will be more clearly understood from the following detailed description when taken in conjunction with the accompanying drawings, in which:

FIG. 1 is a view exemplifying an example of the configuration of a hybrid vehicle to which the present disclosure can be applied;

FIG. 2 is a flowchart showing an example of a hybrid vehicle control method according to the present disclosure;

FIG. 3 is a graph showing a test about a situation in which an EOP driving current decreases when an EOP is driven at a predetermined target RPM and air is suctioned into the EOP;

FIG. 4 is a table showing the situation of FIG. 3; and

FIGS. 5 and 6 are graphs showing a control process according to the present disclosure in accordance with a lapse of time.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

In the following description, the structural or functional description specified to exemplary embodiments according to the concept of the present disclosure is intended to describe the exemplary embodiments, so it should be understood that the present disclosure may be variously embodied, without being limited to the exemplary embodiments.

Embodiments described herein may be changed in various ways and may have various shapes, so specific embodiments are shown in the drawings and will be described in detail in this specification. However, it should be understood that the exemplary embodiments according to the concept of the present disclosure are not limited to the embodiments which will be described hereinbelow with reference to the accompanying drawings, but all of modifications, equivalents, and substitutions are included in the scope and spirit of the present disclosure.

It will be understood that, although the terms first and/or second, etc. may be used herein to describe various elements, these elements should not be limited by these terms. These terms are only used to distinguish one element, from another element. For instance, a first element discussed below could be termed a second element without departing from the right range of the present disclosure. Similarly, the second element could also be termed the first element.

It is to be understood that when one element is referred to as being “connected to” or “coupled to” another element, it may be connected directly to or coupled directly to another element or be connected to or coupled to another element, having the other element intervening therebetween. On the other hand, it should to be understood that when one element is referred to as being “connected directly to” or “coupled directly to” another element, it may be connected to or coupled to another element without the other element intervening therebetween. Further, the terms used herein to describe a relationship between elements, that is, “between”, “directly between”, “adjacent” or “directly adjacent” should be interpreted in the same manner as those described above.

The terminology used herein is for the purpose of describing particular embodiments only and is not intended to limit the present disclosure Singular forms are intended to include plural forms unless the context clearly indicates otherwise.

Unless otherwise defined, all terms including technical and scientific terms used herein have the same meaning as commonly understood by those skilled in the art to which the present disclosure belongs. It must be understood that the terms defined by the dictionary are identical with the meanings within the context of the related art, and they should not be ideally or excessively formally defined unless the context clearly dictates otherwise.

The present disclosure will be described hereafter in detail by describing exemplary embodiments of the present disclosure with reference to the accompanying drawings. Like reference numerals given in the drawings indicate like components.

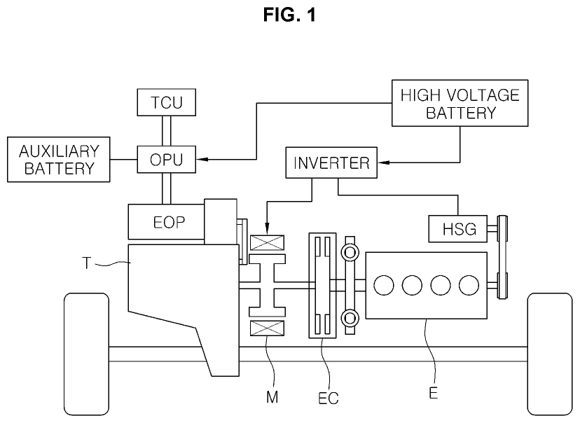

FIG. 1 exemplifies the configuration of a hybrid vehicle to which the present disclosure can be applied, in which power from an engine E can be transmitted to a transmission T through an engine clutch EC, and a motor M is disposed at an input shaft of the transmission T to configure a hybrid powertrain.

An Electric oil pump (EOP) controlled by an Oil Pump Control Unit (OPU) to generate a flow rate of oil to be used to control the transmission T, the engine clutch EC, etc. is provided from the transmission T.

For reference, the engine E has a Hybrid Starter and Generator (HSG) so that the engine E can be started and can generate electricity, and the motor M is controlled by an inverter.

The transmission is controlled by a Transmission Control Unit (TCU) and the OPU is also controlled by the TCU. Accordingly, in the present disclosure, the TCU and the OPU can serve to directly drive the EOP on the basis of an instruction from the TCU.

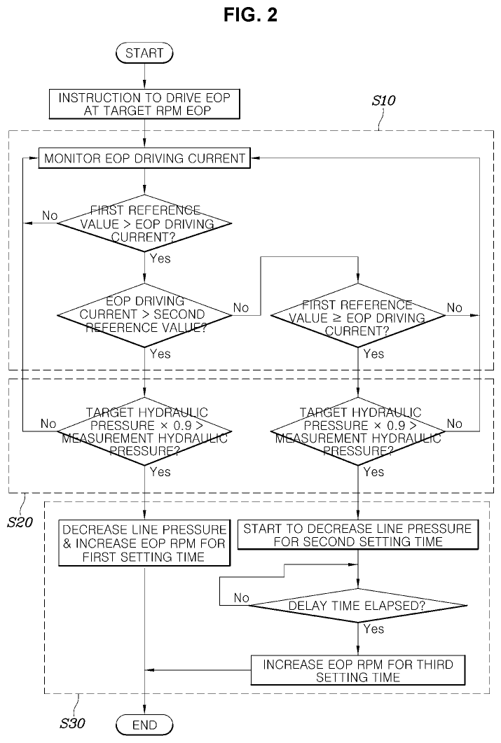

Referring to FIG. 2, an embodiment of the hybrid vehicle control method of the present disclosure includes: monitoring an EOP driving current in which the EOP is being driven at a predetermined target RPM and determining whether the EOP driving current is in a predetermined reference range corresponding to a situation in which the EOP suctions air by a controller (S10); determining whether a measured hydraulic pressure at the place receiving the oil supplied by the EOP is less than a reference hydraulic pressure when the EOP driving current is in the predetermined reference range (S20); and temporarily decreasing line pressure and increasing the RPM of the EOP (S30).

That is, the present disclosure estimates whether the EOP suctions air on the basis of the EOP driving current, which is being driven at a predetermined target RPM, and determines that the EOP suctions air, decreases line pressure, increases the amount of oil returning to an oil pan, and increases the RPM of the EOP when the measured hydraulic pressure is less than the reference hydraulic pressure so that the discharge flow rate of the EOP can be quickly recovered to the normal level, thereby securing operability of the transmission, the engine clutch, etc. and stability of lubricating and cooling functions.

For reference, the line pressure is pressure that is fundamentally generated in a hydraulic circuit in the transmission by the oil supplied from the EOP and the controller sets target line pressure in consideration of the input torque of the transmission, etc., and a regulator valve is controlled on the basis of the target line pressure, whereby line pressure following the target line pressure is generated.

The oil pan is representatively used to express a space where oil that is recovered is stored so that the EOP can suction the oil, which means that the term ‘oil pan’ is not necessarily limited to an oil pan.

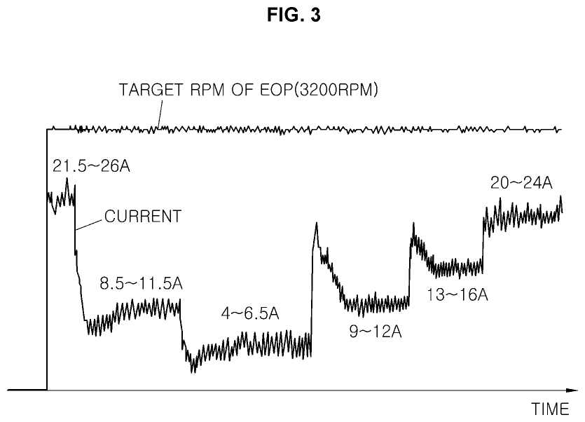

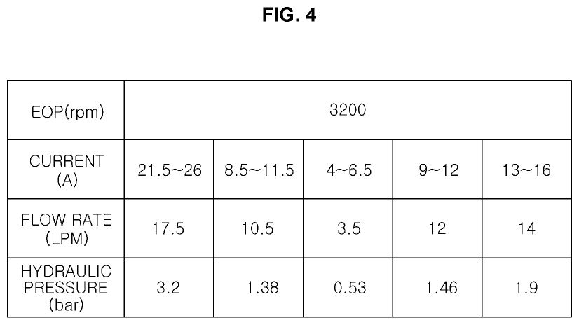

FIG. 3 is a graph showing a change of EOP driving current when the EOP is driven at a predetermined target RPM of 3200 RPM and FIG. 4 is a table corresponding to FIG. 3. It can be seen from the diagrams that when the EOP driving current is less than about 20 A, the discharge flow rate and hydraulic pressure of the EOP are remarkably low, as compared with the EOP driving current is 20 A or more.

It is possible to estimate from the test results of FIGS. 3 and 4 that when the EOP suctions air even though the EOP is driven at the same RPM, the load remarkably decreases, so the EOP driving current decreases.

The present disclosure, which is based on this estimation, estimates first that the EOP suctions air when the EOP driving current is in the predetermined reference range, and finally determines that the EOP suctions air by comparing the measured hydraulic pressure with the reference hydraulic pressure.

The place receiving the oil supplied from the EOP may be the engine clutch connecting the engine and the transmission to each other, and the measured hydraulic pressure may be pressure that is measured by a hydraulic sensor installed on the engine clutch.

Obviously, when the hydraulic sensor that can sense the pressure of the oil supplied from the EOP is installed at another position in the transmission, it may be possible to sense the measured hydraulic pressure using the hydraulic sensor.

The reference hydraulic pressure, for example, may be calculated by target hydraulic pressure * 0.9, as shown in FIG. 2.

The target hydraulic pressure may be considered as hydraulic pressure that is measured by the hydraulic sensor when the EOP is driven at the target RPM in a normal situation in which the EOP does not suction air.

Accordingly, the reference hydraulic pressure is pressure lower than the target hydraulic pressure and may be set such that air suction by the EOP that may be a matter can be detected. To this end, the coefficient such as 0.9 that multiplies the target hydraulic pressure may be appropriately changed in accordance with corresponding transmissions through several tests.

In this embodiment, when the EOP driving current is less than a predetermined first reference value, the EOP driving current is determined as being in the predetermined reference range; and when the EOP driving current is less than or equal to a predetermined second reference value that is smaller than the first reference value and when the measured hydraulic pressure is less than the reference hydraulic pressure, the line pressure is decreased and the RPM of the EOP is increased in a method discriminated from the case in which the EOP driving current exceeds the second reference value.

That is, when the EOP driving current is less than the first reference value, the EOP driving current is in the predetermined reference range, so it is estimated that the EOP suctions air, but the degree of air suction by the EOP is classified by adding the second reference value, whereby the line pressure is decreased and the RPM of the EOP is increased in another way. Accordingly, it is possible to more appropriately cope with the air suction phenomenon by the EOP not to be excessive or insufficient either.

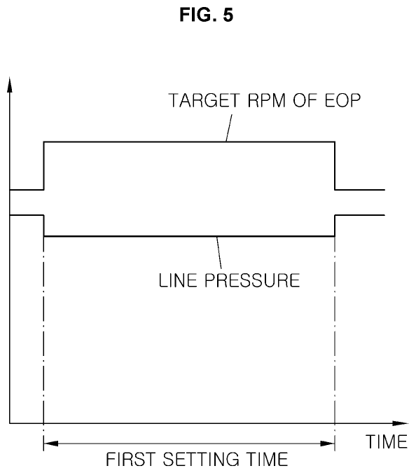

When the EOP driving current is less than the first reference value and exceeds the second reference value and the measured hydraulic pressure is less than the reference hydraulic pressure, the line pressure is decreased by resetting the target line pressure by multiplying the current line pressure by a predetermined first reference ratio for a predetermined first setting time and the RPM of the EOP is increased by resetting the target RPM by adding a predetermined first increment to the current target RPM of the EOP (see FIG. 5).

That is, this case is a situation in which the amount of air suctioned by the EOP is smaller than the case in which the EOP driving current is less than or equal to the second reference value, which will be described below. In this case, the line pressure that is finally supplied to the transmission is decreased to the level of about 90% by multiplying the target line pressure by the first reference ratio such as 0.9 so that the amount of oil returning to the oil pan is increased. Further, the RPM of the EOP is finally increased by adding the first reference increment such as 200 RPM to the target RPM of the EOP so that oil can be smoothly and stably pumped.

Such control is performed for the first setting time and the first setting time may be set, for example, as 500 ms.

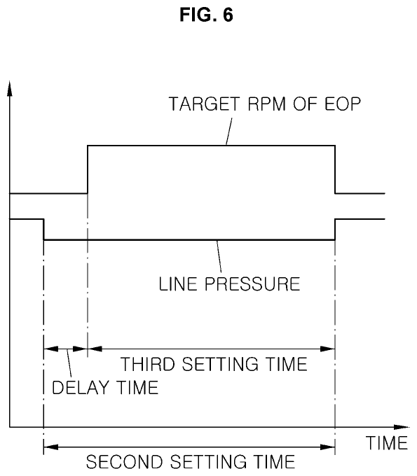

Meanwhile, when the EOP driving current is less than or equal to the second reference value and the measured hydraulic pressure is less than the reference hydraulic pressure, the line pressure is decreased for a predetermined second setting time; and when a predetermined delay time elapses after the line pressure starts to be decreased, the target RPM of the EOP is increased for a predetermined third setting time (see FIG. 6).

The reason of increasing the target RPM of the EOP after the delay time elapses, is for increasing the RPM of the EOP after somewhat securing the amount of oil to be suctioned by the EOP by increasing the amount of oil returning to the oil pan by decreasing the line pressure, as described above, because there is a large possibility of the deterioration of durability of the EOP when the RPM of the EOP is immediately increased when the EOP is already suctioning a large amount of air.

Accordingly, the delay time may be set, for example, as 100 ms in accordance with the purpose described above and, substantially, an appropriate value may be selected through several tests and analysis.

When the line pressure is decreased for the second setting time, the target line pressure is reset by multiplying the current target line pressure by a predetermined second reference ratio that is smaller than the first reference ratio, whereby the line pressure is decreased; and when the target RPM of the EOP is increased for the third setting time, the target RPM is reset by adding a predetermined second increment to the current target RPM of the EOP, whereby the RPM of the EOP can be increased.

The second setting time may be set longer than the first setting time, for example, as 1000 ms in order to be able to cope with a severer air suction situation by the EOP.

As described above, the first setting time and the second setting time, which are measures for decreasing the line pressure and the target RPM of the EOP, are set at levels that can solve the problem of reduction of the discharge flow rate and hydraulic pressure due to air suction by the EOP, and substantially, may be determined by applying several tests and analysis to a vehicle equipped with a corresponding transmission.

The second reference ratio may be set smaller than the first reference ratio, for example, 0.8 such that the line pressure that is supplied to the transmission is finally further decreased to the level of about 80% and the amount of oil returning to the oil pan can be further increased.

The third setting time is expressed to be discriminated from the second setting time because it is time that independently starts after the second setting time starts and the delay time elapses, and may be set to be the same as the second setting time, for example, 1000 ms or may be set to be different. Further, finally, the third setting time may be determined through several tests and analysis such that the discharge flow rate and hydraulic pressure of the EOP can be recovered to the normal level.

Accordingly, the second reference increment may be set to be larger than the first reference increment such as 500 RPM in order to be able to more appropriately cope with the problem of air suction by the EOP, and may be determined through several tests and analysis in terms of designing.

The EOP driving current that is monitored may be a DC current that is simply supplied to the motor of the EOP, but it may contribute to more accurate control to monitor the q-axial current of the motor that more accurately reflects the substantial driving torque of the EOP.

Although the present disclosure was described with reference to specific embodiments shown in the drawings, it is apparent to those skilled in the art that the present disclosure may be changed and modified in various ways without departing from the scope of the present disclosure which is described in the following claims.

What is claimed is:

1. A hybrid vehicle control method comprising:
monitoring an electric oil pump (EOP) driving current in which an EOP is being driven at a predetermined target RPM, and determining whether the EOP driving current is in a predetermined reference range corresponding to a situation in which the EOP suctions air;
determining whether a measured hydraulic pressure at a place receiving oil supplied by the EOP is less than a reference hydraulic pressure when the EOP driving current is in the predetermined reference range; and
temporarily decreasing line pressure and increasing an RPM of the EOP.

2. The hybrid vehicle control method of claim 1, wherein when the EOP driving current is less than a predetermined first reference value, the EOP driving current is determined as being in the predetermined reference range; and
when the EOP driving current is less than or equal to a predetermined second reference value that is smaller than the first reference value and when the measured hydraulic pressure is less than the reference hydraulic pressure, the line pressure is decreased and the RPM of the EOP is increased in a method discriminated from a case in which the EOP driving current exceeds the second reference value.

3. The hybrid vehicle control method of claim 1, wherein when the EOP driving current is less than the first reference value, EOC driving current is determined as being in the predetermined reference range; and
when the EOP driving current exceeds a predetermined second reference value that is smaller than the first reference value and the measured hydraulic pressure is less than the reference hydraulic pressure, the line pressure is decreased by resetting target line pressure by multiplying current line pressure by a predetermined first reference ratio for a predetermined first setting time and the RPM of the EOP is increased by resetting the target RPM by adding a predetermined first increment to a current target RPM of the EOP.

4. The hybrid vehicle control method of claim 2, wherein when the EOP driving current is less than or equal to the second reference value and the measured hydraulic pressure is less than the reference hydraulic pressure, the line pressure is decreased for a predetermined second setting time that is discriminated from the predetermined first setting time that is used when the EOP driving current exceeds the second reference value and the measured hydraulic pressure is less than the reference hydraulic pressure; and
when a predetermined delay time elapses after the line pressure start to be decreased, the target RPM of the EOP is increased for a predetermined third setting time.

5. The hybrid vehicle control method of claim 4, wherein when the second line pressure is decreased for the second setting time, the target line pressure is reset by multiplying current target line pressure by a predetermined second reference ratio that is smaller than the first reference ratio, whereby the line pressure is decreased; and
when the RPM of the EOP is increased for the third setting time, the target RPM is reset by adding a predetermined second increment to a current target RPM of the EOP, whereby the RPM of the EOP is increased.

6. The hybrid vehicle control method of claim 1, wherein the EOP driving current that is monitored is a q-axial current of a motor driving the EOP.

7. The hybrid vehicle control method of claim 1, wherein the place receiving the oil supplied from the EOP is an engine clutch connecting an engine and a transmission to each other; and
the measured hydraulic pressure is pressure that is measured by a hydraulic sensor installed on the engine clutch.
